(19) United States
(12) Patent Application Publication
(10) Pub. No.: US 2026/0356542 A1
(43) Pub. Date: Nov. 12, 2026

(54) A CLOSING MEANS FOR A FLEXIBLE PACKAGE, A FLEXIBLE PACKAGE WITH A CLOSING MEANS, AND A METHOD FOR MANUFACTURING A PACKAGE WITH A CLOSING MEANS

(71) Applicant: CREAMILL OY, Tampere (FI)

(72) Inventor: Matti KOSKINEN, Tampere (FI)

(73) Assignee: CREAMILL OY, Tampere (FI)

(21) Appl. No.: 18/997,594

(22) PCT Filed: Jul. 5, 2023
(86) PCT No.: PCT/FI2023/050429

§ 371 Date: Jan. 22, 2025

(30) Foreign Application Priority Data
Jul. 22, 2022 (FI) 20225685
Nov. 18, 2022 (FI) 20226034

(51) Int. Cl. B65D 33/16; B31B 70/60; B65D 33/02; B65D 65/46

(52) U.S. Cl. CPC B65D 33/1691; B31B 70/60; B65D 33/02; B65D 65/466

(57) ABSTRACT

A closing means for closing an open side of a flexible package includes a material blank provided with two creases, an attachment surface, a re-closable closing surface, and a non-adhesive surface. The attachment surface is provided with adhesive for attaching the flexible package to the first outer wall. The attachment surface is between the first flank and the first crease of the closing means. The non-adhesive surface of the closing means is between the second crease and the second flank of the closing means. Adhesive is provided on the re-closable closing surface between the first and second creases. The closing surface is arranged to be removably attached, in the closed position, across the open side of the flexible package to the second outer wall of the flexible package and, in the closed position, to the non-adhesive surface of the closing means.

### FIELD OF THE INVENTION

The invention relates to a closing means for a flexible package, by which the flexible package can be closed or re-closed after being opened. The invention also relates to a flexible package with a closing means, as well as to a method for manufacturing a flexible package with a closing means.

### BACKGROUND OF THE INVENTION

Flexible packages, such as bags, made of paper and fibre material, are conventionally closed by an adhesive area, for example with glue, by ultrasonic sealing or by heat sealing. When the package is opened, different parts of the package are separated from each other mechanically, for example by pulling the parts apart in a direction transverse to a seam or, in case of a flap, by tearing the flap off the package at the side where it has been sealed. Aluminium foil packages, such as peanut bags, in turn, can be opened, for example, by tearing off a material area at the top of the bag, over the whole width of the top of the bag. Plastic packages, such as bags of sweets, can be opened in a way similar to foil bags, by tearing off a material area at the top of the bag, over the whole width of the top of the bag, or at a corner of the bag, or by pulling the front and rear parts of the bag in opposite directions, whereby the seam formed by a glued or other adhesive area at the top of the bag is opened by detaching from at least one surface.

A problem with many conventional flexible packages is the fact that when opened, they can no longer be closed without a separate closing device. However, closing is advantageous for many products contained in the package, for example to ensure better preservability of food but also to prevent the material contained in the opened package from accidentally leaking from the package and messing the environment, such as a handbag or a backpack. Some foil bags or plastic packages comprise a closing structure resealable by pressure, for example a so-called zipper closure based on Minigrip^{R} technique, at the top of the package, that is, double grooves on the first inner wall of the package and a groove on the second inner wall. This structure is closed by pressing the single groove between the double grooves. However, the material of this solution is generally non-biodegradable plastic, and it is not preferable or suitable for every material type, for example for a paper bag, due to its poor resistance to tension. Closing means made of biodegradable plastic and based on the zipper i.e. Minigrip^{R} technique exist, but this material interferes with the recycling of fibres as well. Naturally, these closing means can be removed from a recyclable package by tearing or cutting them off before recycling, but this involves extra work. Flexible packages may also comprise a re-closable tape strip, seal or adhesive band or adhesive lines which are attached to either one of the inner walls or, in a bag structure with a flap, between the outer wall of the package and the flap to be attached to it. In structures with tapes and adhesive bands, re-closing solutions may involve the problem that because the adhesive structure is unprotected when the bag is open, material from the environment or from the contents of the bag may accumulate on the tape or adhesive band and prevent or hamper its re-closure.

### BRIEF SUMMARY OF THE INVENTION

It is an aim of the present invention to provide and present a novel closing means for a flexible bag, a flexible package with a closing means, as well as a method for manufacturing a flexible bag with a closing means. The scope of the different embodiments of the invention is defined in the independent claims. Some additional features are defined in the dependent claims. The embodiments, examples and possible features described in this specification and not falling within the scope of the independent claims shall be interpreted as examples which are useful for understanding the different embodiments of the invention.

### DESCRIPTION OF THE DRAWINGS

In the following, the invention will be described in more detail with reference to the appended drawings, in which

FIG. 1a shows a package closing means according to an embodiment, in a cross-sectional side view of a package and of the closing means when the closing means is attached to the flexible package and is in the open position;

FIG. 1b shows the package and the closing means of FIG. 1a in a cross-sectional side view when the closing means is in the closed position, closing the flexible package;

FIG. 2a shows a package closing means according to an embodiment in the side view of a package and of the closing means when the closing means is attached to the flexible package and is in the open position;

FIG. 2b shows the package and the closing means of FIG. 2a in a cross-sectional side view when the closing means is in the closed position, closing the flexible package;

FIG. 3a shows a flexible package closed by a closing means according to an embodiment and seen from the direction of the surface opposite to that on which the closing means is attached;

FIG. 3b shows the flexible package of FIG. 3a when the package is opened and the closing means is in the open position;

FIG. 3c shows the flexible package of FIG. 3a when the package is closed and the closing means is in the closed position;

FIG. 4 shows a method of manufacturing a paper package according to the invention in a flow chart;

FIG. 5 shows a package closing means according to an embodiment in a side view of the package and of the closing means when the closing means is attached to the flexible package;

FIG. 6a shows a closing means for a flexible package according to an embodiment, seen from the direction of the closing surface, on which it comprises different surface materials,

FIG. 6b shows a perspective view of the closing means for a flexible package according to FIG. 6a,

FIG. 6c shows the closing means and the flexible package of FIG. 6a in a cross-sectional side view when the closing means is attached to the flexible package but not placed in a closed or open position;

FIG. 6d shows the package of FIG. 6c and the closing means of FIGS. 6a, 6b in a cross-sectional side view when the closing means is in the closed position and closes the flexible package and its open side;

FIG. 6e shows the package of FIG. 6c and the closing means of FIGS. 6a, 6b in a cross-sectional side view when the closing means is in an open position and leaves the flexible package and its open side open;

FIG. 7a shows a closing means for a flexible package according to an embodiment, equipped with a gripping flap, seen from the direction of the closing surface on which it comprises different surface materials,

FIG. 7b shows the closing means for a flexible package as shown in FIG. 7a, seen from the end of the closing means,

FIG. 7c shows the closing means and the flexible package of FIGS. 7a, 7b in a cross-sectional side view when the closing means is attached to the flexible package but not placed in a closed or open position;

FIG. 7d shows the closing means of FIGS. 7a, 7b and the flexible package of FIG. 7c in a cross-sectional side view when the closing means is in the closed position and closes the flexible package and its open side;

FIG. 7e shows the closing means of FIGS. 7a, 7b and the flexible package of FIGS. 7c, 7d in a front view;

FIG. 8 shows a front view of a closing means according to an embodiment of the invention, attached to a flexible package;

FIG. 9a shows a closing means for a flexible package according to an embodiment of the invention;

FIG. 9b shows the closing means of FIG. 9a attached to a flexible package;

FIG. 10a shows the structure of a flexible package equipped with a closing means according to an embodiment, in a cross-sectional side view;

FIG. 10b shows a cross-sectional side view of the flexible package equipped with a closing means as shown in FIG. 10a, the openable side heat-sealed, before the flexible package is opened;

FIG. 10c shows a cross-sectional side view of the flexible package equipped with a closing means as shown in FIG. 10b, after the flexible package has been opened;

FIG. 10d shows a cross-sectional side view of the flexible package equipped with a closing means as shown in FIG. 10c, after the flexible package has been re-closed; and

FIG. 11 shows a front view of a flexible package according to an embodiment, equipped with a reinforcement and a closing means, the closing means and the reinforcement being attached to the package and the package being in the open position.

### DETAILED DESCRIPTION OF THE INVENTION

As already mentioned under Background of the invention, flexible packages, such as paper, plastic or aluminium foil packages and bags, are conventionally closed by an adhesive area, for example with glue, by ultrasonic sealing or by heat sealing. When the package is opened, different parts of the package, most commonly opposite walls, are separated from each other mechanically, for example by pulling the walls apart in a direction transverse to the seam, whereby the seam formed by the glue or other adhesive area at the top of the bag is opened by detaching from at least one surface or, alternatively, the seam is split. In case of a flexible package with a flap, the package can be opened by detaching the flap from the wall on which it has been sealed. In this application, a wall refers to a wall delimiting the package, or a part of a wall. Some flexible packages, such as peanut bags made of aluminium foil, can also be opened, for example, by tearing off a material area at the top of the bag, over the whole width of the top of the bag. Plastic packages, such as bags of sweets, can be opened in a similar way by tearing off a material area at the top of the bag, over the whole width of the top of the bag, or by removing a material area at a corner of the bag.

A problem with many flexible packages is thus the fact that after being opened, they can no longer be closed without a separate closing means, such as a plastic or metal clip or clamp or a closing means containing a metal wire and used by twisting or clamping the parts together. However, it is preferable to close an opened package, to ensure better preservability and cleanliness of the products, such as food, contained in the package, but also to keep the products packed in the bag. A re-closable flexible package also improves the possibility of re-using the flexible package as well as reduces the need to move the products of the package to another package after opening.

It is true that there are re-closable flexible packages provided with a flap and an adhesive surface spaced by, for example, 15 mm from the top edge of the bag. One reason for the spacing is presumably to prevent fingers from touching the adhesive surface when opening the bag. A problem with such a solution is that the bag is not closed tightly by the flap because the 15 mm gap is left at the corners after fastening the flap with the adhesive. Also, the adhesive surface often comprises a separate strip to be pulled off the adhesive surface, for example a strip of paper or plastic, to protect the adhesive before using the adhesive surface. After being taken into use, the unprotected adhesive surface is also exposed to dirt when the package is open.

There is thus a need for an inexpensive, uncontaminated closing means, i.e. a closing solution, which is easy to use and which closes and re-closes the flexible package in a reliable way. The closing means according to the invention is intended to close and re-close flexible packages, such as paper, plastic or aluminium foil packages and bags, as well as flexible packages made of other flexible materials, or other packages, containers, and bags suitable to be closed with a closing means according to the invention. Consequently, there are no restrictions to the material of the flexible packages to be closed by the closing means according to the invention because the closing means is suitable for use in various bags of fibre material, plastic and foil as well as, in some cases, rigid cardboard packages. Also, many fibre materials which are being or will be developed are probably suitable for materials for the closing means and the flexible bag. However, it should be noted that the closing means according to the invention is a particularly advantageous solution for use in flexible packages made of recyclable fibre materials, i.e. primarily recyclable paper, and particularly when the closing means is made of the same material as the flexible package, because a plastic closing means will thus not disturb or prevent the recyclability of the flexible package provided with the closing means. In the light of current research, paper can be recycled several times, if desired, as many as 10 times, which further manifests the preferable choice of paper as a material for a flexible package. The same applies for cardboard, because cardboard, which is a biodegradable material, can be recycled a number of times, even 25 times. On the other hand, food manufacturers prefer or may prefer virgin fibre in packages which are in direct contact with food, such as moist or fatty food, for example chocolate, for reasons of hygiene. Furthermore, it should be remembered that recycling of material is more preferable than composting it. Therefore, it is highly environmentally friendly and preferable to recover the fibre of flexible fibre packages for recycling and re-use instead of composting, until the mechanical properties of the fibres are diminished.

The closing means according to the invention comprises a material blank with at least two creases. Between a first flank and a first crease of the closing means, an attachment surface is provided, on which a first adhesive coating of i.e. hot-setting adhesive is applied, for attaching the closing means to the outer wall of the flexible package. If the adhesive coating is provided on the closing surface of the closing means, i.e. on the surface which faces the opening of the closing means when the closing means closes the package, the first flank faces away from the opening side i.e. the mouth of the bag and downwards. If the adhesive coating is provided on the surface opposite to the closing surface of the closing means, the first flank faces the mouth of the bag and upwards.

Between the first and second creases, the closing means comprises a re-closable closing surface. A non-adhesive surface is provided between the second crease and the second flank of the closing means. The non-adhesive surface may consist of, for example, silicone or any other suitable material. On the re-closable surface, a second adhesive coating is applied, consisting of e.g. adhesive which does not stick permanently when the re-closable closing surface and the non-adhesive surface are folded against each other in the open position. By the adhesive on the re-closable closing surface, the closing means is removably attached, in the closed position, across the open side of the flexible package to the outer wall of the flexible package opposite to the fastening surface, to close the flexible package. In other words, the closing means is considered to be open, i.e. folded, when the closing surface is removably attached to the non-adhesive surface, i.e. the so-called release layer, and the closing means does not close the package. In the present application, the term crease comprises locations where the closing means is folded or where it is foldable or where it is intended to be folded in use. In connection with the present application, a flexible package as well as a carbon package may also be referred to by the term “package” alone.

Of flexible packages which can be closed by a closing means according to the invention, paper packages are packages made of paper or combinations, i.e. laminates, of paper and other materials. Paper grades typically have a gram-mage lower than 250 g/m², lower than 180 g/m², or lower than 125 g/m², such as 20 to 250 g/m², 40 to 180 g/m², or 60 to 125 g/m². The paper used in flexible packages is preferably recyclable, but it may also be compostable or biodegradable. However, the term recyclable flexible paper package only refers to flexible packages made of recyclable paper. Although a paper package is normally made of wood-based or other vegetable fibres, the material may also contain other fibres. Thus, raw materials for recyclable flexible paper package material include wood-based or cellulose-based and other vegetable fibres. Raw materials for a compostable or biodegradable flexible package material also include biodegradable synthetic fibres.

A laminate for a paper package may comprise two or more material layers, one of which typically consists of paper. In other words, the laminate may comprise, for example, one layer of paper and another layer of another material, or, for example, three different layers, of which one layer comprises paper and two other layers comprise other materials. The appropriate order of the layers in the laminate may be selected according to the use. Typically, paper constitutes the outermost layer in the laminate. One or more layers of the laminate may comprise fibre materials. As the fibre material, it is possible to use paper or other wood or pulp based fibre materials, such as wood fibre or non-woven materials. Preferably, any non-recyclable fibre material used in the laminate is, nevertheless, biodegradable or compostable. One or more layers of the laminate may also comprise wood or pulp based materials other than fibre materials, such as film materials. Cellulose film can also be used as a film material, and plastics can be used as layers in the laminate. The plastic used in the laminate may be selected from the group of polyethylene (PE), polypropylene (PP), polyethylene terephtalate (PET), bio-based and/or biodegradable plastics, such as polycaprolactone (PLC), polyvinyl alcohol (PVOH), polylactide (PLA), as well as combinations of these. Preferably, the paper-plastic laminate comprises paper and biodegradable plastic, which guarantees compostability of the package, particularly advantageously paper and polylactide (PLA). Layers of the laminate may comprise biodegradable or compostable barrier material made by an aqueous dispersion technique and not comprising plastics. If this barrier layer is the innermost layer in the laminate (the layer left inside the package), it is preferably heat sealable or ultrasonically sealable. The paper package can also be made of a laminate comprising paper and heat sealable or ultrasonically sealable material. The package may also be made of a heat sealable or ultrasonically sealable paper-plastic laminate or a laminate comprising paper and biodegradable or compostable barrier material made by an aqueous dispersion technique which does not comprise plastics, or the paper package can be made of a heat sealable or ultrasonically sealable biodegradable paper-plastic laminate, such as a paper-polylactide (PLA) laminate. The heat sealable or ultrasonically sealable laminate may also comprise paper and biodegradable or compostable barrier material made by an aqueous dispersion technique (so-called paper-barrier laminate).

Plastic packages, in turn, may consist of, for example, polyethylene (LDPE), polypropylene (PP) film, or another plastic package material suitable for packing the material in question, preferably recyclable plastic packaging material. Aluminium foil packages are normally aluminium-plastic composite vacuum-packed bags. Such packages are suitable for vacuum, moisture and light-protection packaging of, for example, coffee, large precision machines, chemical raw materials and intermediate pharmaceutical products.

The material of a blank for a closing means intended for closing and re-closing a flexible package according to the invention, i.e. the so-called substrate material, can be selected according to the material of the flexible package. It may be the same material as the material of the flexible package, to which the closing means is attached, or a different material. It may thus be, for example, paper, plastic, recyclable or compostable fibre material, or compostable foil or foil material, that is, film or film material, such as NatureFlex™ or the like, or it may be made of a single area of monomaterial or it may be composed of several strips of different materials, such as paper and cardboard, whereby the blank thus comprises several different materials. Examples include the following flexible packages provided with a closing means: a recyclable flexible paper package with a closing means of paper; a flexible paper package with a closing means of recyclable paper; a flexible paper package with a closing means of non-recyclable paper; a biodegradable or compostable flexible fibre package with a closing means of laminate; a recyclable flexible paper package with a closing means of laminate; a flexible plastic package with a closing means of plastic; a flexible aluminium foil package with a closing means of aluminium foil; or any other combination of these materials and closing means.

When the closing means, i.e. the material of the blank for the closing means, consists a laminate, such as a cellulosic NatureFlex™ film which is a plastic-like material poorly permeable to oxygen, it has the advantage that the material acts, in the open position, as a protection for the re-closable closing surface so that the adhesive applied on it cannot dry, at least not very easily; furthermore, the non-adhesive protection does not need to be provided with a separate coating but the blank material itself acts as the non-adhesive surface. The same applies to blanks made of plastic and aluminium foil: the blank material prevents oxidation of the adhesive and acts, as such, as the non-adhesive surface for the adhesive of the closing means in the open position or in case the second surface of the blank for the closing means, i.e. the surface not provided with adhesive coatings/areas, is coated with silicone.

The adhesive coatings of the closing means can be provided in the blank as an adhesive area, stripe or stripes of one or more different glues on the fastening surface and the re-closable closing surface. In this context, ‘providing’ refers to applying i.e. gluing adhesive on the surface of the blank. The adhesive used can be any suitable adhesive which is preferably made of any suitable glue known in the manufacture of pressure-sensitive labels, such as hot-melt, acrylic emulsions, transfer adhesives, glue, chemically reactive type glues, but it can also be formed of other suitable adhesives. The adhesive may be selected by considering or not considering the requirements of recyclability and compostability. Furthermore, the adhesive may be selected depending on the product packed in the package, whether it is food or another product. Moisture and a barrier may also set their own requirements on the adhesive to be used. The closing means can be attached by hot sealing, particularly to plastic bags. To paper and cardboard packages, the closing means is attached primarily by hot-setting adhesive, but liquid glue is feasible as well.

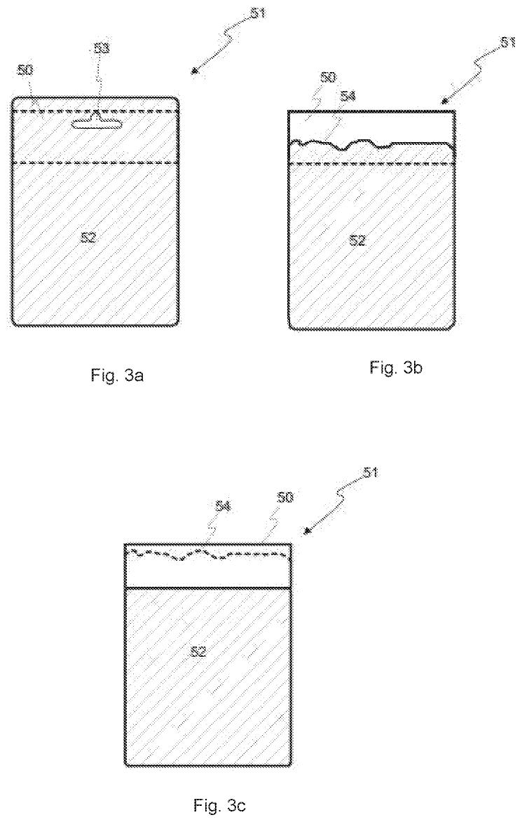

The material and/or the adhesive coating of the blank for the closing means can also be selected, for example, according to the probable way of opening the package material. For example, if the package is probably opened unevenly, as shown in FIGS. 3b to 3c, it is preferable that the closing means has a more rigid structure and the crease between its non-adhesive surface and adhesive closing surface acts as a hinge like the crease. Even if the material of the closing means were flexible in other respects, it is possible, for example, to stiffen at least the re-closable closing surface by a separate material layer. A closing means with a more rigid structure is easier to open and close. If the top edge of the flexible package is completely straight or it remains completely or substantially straight when opened, it is possible that the closing surface is also flexible like, for example, paper tape or conventional plastic-based adhesive tape. In the case of a simple flap, the edge area of the second flank of the closing means, for example the section between the second flank and the closing surface, is without adhesive, and the user can grip it to place the closing means in closed position and open position. The flap may be stiffened as well.

The stiffening can be implemented by means of a second material layer, i.e. by gluing one or more additional material layers in the flap area, i.e. the edge area on the second flank of the closing surface, or, in the case of a thinner blank material for the closing means, by folding a short section, that is, a sufficient length, of the closing surface double from the direction of the flank opposite to the flank attached to the package. For example, if the material of the blank for the closing means is laminate, such as the above mentioned NatureFlex™ film, or if the second surface is coated with silicone, and the closing means can be provided with a stiffened flap by folding part of the closing surface double so that part of the coating or silicone surface is folded onto the adhesive coating, a rigid flap is formed which does not adhere to the glue stripe. In plastic and foil packages, the edge is not folded or does not necessarily need to be folded, because these materials have a sufficiently high intrinsic tensile strength so that they can easily resist the tension needed for opening and closing. The reinforcement and the non-adhesive surface of the flap can also be provided by a separate material strip, that is, for example, adhesive tape, or by applying glue onto the edge area of the second flank of the closing surface and arranging the material strip in this area.

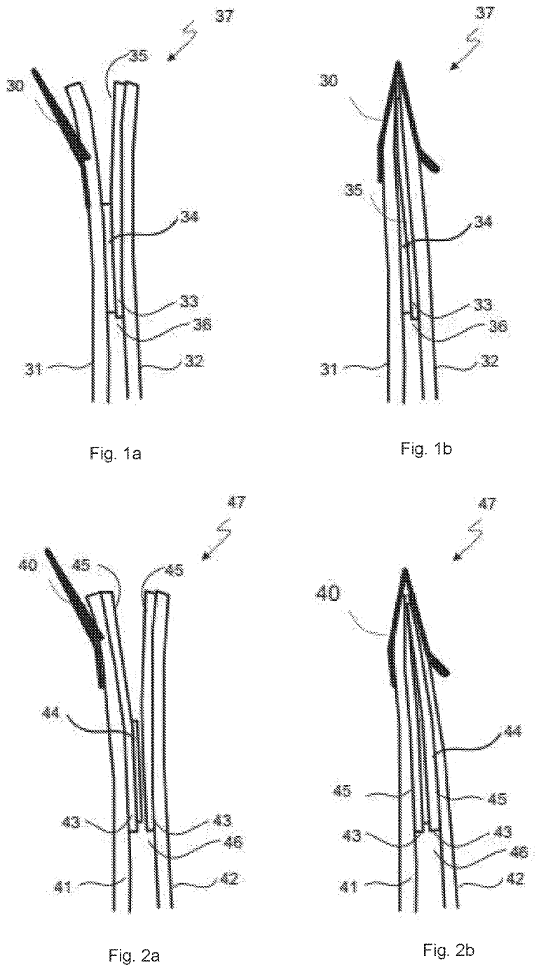

The closing means is either suitable as such or modifiable to close packages to be opened in different ways, such as those to be torn open by the side, wherein a material section is torn off the top of the package, or so-called ez2open bags (see FIGS. 1a-b, 2a-b), coffee packages, or perforated bags. It is also suitable for closing flexible packages which have not been closed by sealing or gluing, such as conventional paper bags, plastic bags etc. without a seam at the top.

The most advantageous way to manufacture and provide the closing means to a manufacturer of flexible packages is, in many cases, the form of a band coiled in a roll. In the roll, the closing means may be folded ready in two or more layers, that is, for example in a so-called open position, or it may be in the form of an unfolded band. The closing means may be folded up in the roll so that its edges are aligned or not aligned.

In the form of a band, the closing means can be attached to the package material at the stage when the package material is discharged from a roll to a machine for folding up bags, by means of an adhesive that is sufficiently strong for the purpose. The closing means may also be attached to a finished flexible package or cardboard box first after the flexible package or cardboard box is complete, i.e. in its final shape and possibly even filled.

Preferably, when a consumer opens the seam of the flexible package, the adhesive on the closing surface of the closing means is completely protected within the crease, i.e. in the open position, whereby the consumer's fingers do not touch the area of the adhesive coating. Furthermore, if the package contains, for example, a powdery product, the powder cannot block the adhesive on the re-closable closing surface of the closing means in the open position, because this surface is attached to the non-adhesive surface. Moreover, as already mentioned above, in the open position, the adhesive on the closing surface of the closing means is provided between two surfaces of silicone, plastic, aluminium foil, or the like, protected from drying. Consequently, in the closing means according to the invention, there is no need at any stage for a separate strip on the adhesive to protect the adhesive coating, because the adhesive of the closing surface is always either against the non-adhesive surface of the closing means, in the open position, or against the wall of the package, in the closed position.

As the top surfaces of the walls on the open sides of the packages are flat, the open sides can be tightly closed by the closing means, in some cases even to be almost air-tight.

The invention also relates to a flexible package comprising a closing means according to the invention, that is, a flexible package with a closing means. One such flexible package with a closing means is a paper package, for example a recyclable paper package, in which the seam closing the package is provided with a fibre rip stopper. The paper package comprises at least a first package wall and a second package wall, as well as an adhesive area between the first wall and the second wall. The adhesive area forms the seam closing the package. The paper package further comprises at least one fibre rip stopper at the edge of the adhesive area or spaced from it in the direction of the interior of the package. The fibre rip stopper is configured to delimit the dividing line between the first wall and the second wall to the edge of the adhesive area or to a space from it in the direction of the interior of the package when the package is opened.

The fibre rip stopper may also be arranged at a distance from the edge of the adhesive area towards the end point of the package wall. The end point may be a point where a fold is provided in said wall, or a point where the wall and the bottom of the package are joined.

Such a paper package has the advantage of being easy to open, compared with conventional paper packages sealed by gluing, ultrasonic sealing or heat sealing. The package is opened without the fibre rip extending down the wall of the package, so that the package is neatly opened at the desired location only. The package according to the invention cannot be torn down the wall of the package since the fibre rip is stopped by the fibre rip stopper. Different embodiments of the fibre rip stopper are presented in more detail in the applicant's earlier international patent application PCT/FI2022/050484.

FIG. 1a shows a cross-sectional side view of the above-mentioned paper package provided with closing means according to the invention, in which a closing means 30 is attached to a paper package 37 comprising a fibre rip stopper 33, when the closing means 30 is in the open position. The package 37 comprises at least a first wall 31 and a second wall 32, as well as an adhesive area 34 between the first wall 31 and the second wall 32. The adhesive area 34 constitutes the seam closing the package 37 and its openable side. The package 37 further comprises at least one fibre rip stopper 33 at the edge of the adhesive area 34. The fibre rip stopper 33 is provided to delimit the point separating the first wall 31 and the second wall 32 to the edge of the adhesive area 34 when the package 37 is opened.

The first wall 31 and the second wall 32 of the package 37 may be attached to each other at the sides of the package by means of adhesive, such as glue, by ultrasonic sealing or heat sealing, or by another suitable method.

The first wall 31 and the second wall 32 may each be separately formed of one or more pieces of material. The walls 31, 32 of the package 37 may be formed of a single continuous piece of material, or two or more pieces of material attached to each other. The wall 31 or 32 of the package 37 may comprise a vertical seam or several vertical seams. The package 37 may be arranged to be sealed in an air-tight manner, whereby it is particularly suitable for packing food. The package is opened by detaching the first wall 31 and the second wall 32 from each other at the adhesive area 34. The detaching is facilitated by the fact that extending from the adhesive area 34 outwards (seen from the direction of the package), the first wall 31 and the second wall 32 are detached from each other, forming gripping flaps. By gripping the gripping flaps from the outside of the package, the walls 31, 32 can be easily torn off each other. In FIG. 1a, the closing means 30 is in the open position, attached to the outer surface of the first wall 31 of the package 37. FIG. 1b shows the closing means 30 and the package 37 of FIG. 1a, but in this FIG. 1b the package has been opened and re-closed by the closing means 30 which closes the opened top side of the package 37, because the closing surface of the closing means 30 is attached to the outer surface of the second wall 32 of the package 37, across the opened top side of the package 37.

FIG. 2a shows a package closing means 40 according to the invention in a cross-sectional side view where the closing means 40 is attached to a flexible package 47 comprising two fibre rip stoppers 43. The closing means 40 is in the open position. The first fibre rip stopper 43 is provided inside the package 47, in the adhesive area 44 on the side of the first wall 41, and the second fibre rip stopper 43 is provided inside the package 47, in the adhesive area 44 on the side of the second wall 42. This embodiment has the advantage that the fibre rip cannot extend further on either side of the adhesive area 44. The package 47 will always open so that the fibre rip does not extend across the mouth 46 of the package 47 or beyond the edge of the adhesive area 44. Thus, neither wall 41, 42 of the package 47 is damaged when the package 47 is opened. The contents and the walls 41, 42 of the package 47 will remain of high quality when the package 47 is opened. FIG. 2b shows the closing means 40 and the package 47 of FIG. 2a, but in this FIG. 2b the package 47 has been opened and re-closed by the closing means 40, and the closing means 40 is in the closed position and closes the opened top side of the package 47 after the closing surface of the closing means 40 has been attached to the outer surface of the second wall 42 of the package 47, across the opened top side of the package 47.

In some packages, the fibre rip stopper may be arranged as a slit or an incision in the first wall or the second wall of the flexible package. Thanks to the slit, the fibre rip will be automatically stopped, whereby the package is easy to open, and the wall of the package is not damaged by the fibre rip. In some packages, the fibre rip stopper is formed of a tab, such as a slip of paper or paper tape, which is provided between the first wall and the adhesive area or between the second wall and the adhesive area so that the edge of the tab and the edge of the adhesive area are substantially on top of each other. The package can be opened by tearing at the top of the package, as shown in FIGS. 1a, 1b, 2a, 2b. The edge of the tab acts as the stopper for a fibre rip when the tab and the adhesive area are arranged so that their edges extend substantially on top of each other, that is, along the same line in alignment with the upper edge of the package, or when the stopper for a fibre rip is spaced by a distance d from the adhesive area in the direction of the inner part of the package.

Like the walls, the tab can consist of recyclable paper, i.e. a slip of paper, or a paper tape, i.e. a slip of paper tape. It may also consist of the same material as the walls of the package, or of a different material. Instead of recyclable paper, the tab may thus be made of a compostable fibre material, i.e. it may be a slip of compostable fibre material, or it may be made of a laminate comprising paper, i.e. be a slip of laminate comprising paper. Because the adhesive area is attached to this tab, fibres from the tab may adhere to it when the package is opened, but thanks to the stopper for a fibre rip, this fibre rip caused by gripping cannot extend beyond the stopper for a fibre rip. Thus, the tab made of paper or other compostable fibre material may also be a piece, a slip or an area of adhesive paper tape which comprises compostable or recyclable pressure sensitive adhesive on its first planar surface and heat sealable or ultrasonically sealable material on its opposite second surface. It may also be possible to use heat sensitive adhesive instead of pressure sensitive adhesive on the first planar surface. The heat sensitive adhesive will adhere to the package material at a thermal position substantially lower than the temperature at which heat sealable material possibly provided on the first surface is sealed. The heat sensitive adhesive may also consist of compostable or recyclable material. The heat sealable or ultrasonically sealable material may comprise paper and biodegradable or compostable barrier material made by an aqueous dispersion technique and not comprising plastics. A requirement for opening of the package or bag without problems is that the tabs are detached from each other outside the adhesive area so that they can gripped from the outside of the package or bag and it can be secured that the package will rip open neatly at the adhesive area.

FIG. 3a shows a flexible package 51 with a closing means according to an embodiment. The flexible package 51 with a closing means comprises a closing means 50 according to the invention and a bag-like flexible plastic package 52. The closing means 50 is attached by the attaching surface (not shown) to the wall of the package 52 which, in the position shown in the figure, is the so-called rear wall of the package 52. In FIG. 3a, the closing means 50 is shown by a broken line, because from this angle, the closing means 50 is left behind the package 52. The closing means is in the open position. The package 51 is provided with a hang hole 53, for example a so-called euro hole, for hanging on a bar in a store. The bag shown in FIG. 3a is particularly suitable for packing sweets or snacks. Below the hang hole 53, there is a point where the package 51 is intended to be ripped open from the side. The point may be, for example, a small notch on the side of the package 51, for facilitating the tearing off of the top of the package 51.

FIG. 3b shows the flexible package 51 with a closing means, as shown in FIG. 3a, after the package 51 has been opened by tearing off the top of the package 51. As shown, the torn opening line 54 is uneven. The closing means 50 is still in the open position; that is, the closing surface of the closing means 50 is glued against the non-adhesive surface of the closing means 50. The top of the closing means 50 is now visible, but the lower part of the closing means, whose attaching surface has been attached to the package 52 by, for example, heat sealing, is still shown by a broken line because it is left behind the package 52.

FIG. 3c shows the flexible package 51 with a closing means, as shown in FIGS. 3a and 3b, after then package 53 has been closed by the closing means 50; in other words, the closing means 50 is in the closed position and its closing surface is glued against the outer surface of the front wall of the package. The torn opening line 54 is now shown by broken lines because it is left under the closing means 50.

The flexible package with a closing means according to the invention, i.e. the flexible package comprising a closing means, can be made by a method comprising at least the following steps:
providing a piece of material, for example a piece of recyclable paper, to form the first wall of the package, and a piece of paper to form the second wall of the package; the piece of paper may also be a single uniform piece of paper which is folded to form two pieces of paper: the first one for the first wall and the second one for the second wall;
providing a roll of closing means, preferably folded in the open position;
attaching the closing means material to a wall of the package;
fastening the first wall and the second wall of the package to each other, for example at the sides or the rear seam of the package, for example in the case of a single continuous piece of paper, which fastening is done by using an adhesive, such as glue, by ultrasonic sealing or by heat sealing; and
providing an adhesive area between the first wall and the second wall of the package to form a seam closing the package.

In the above mentioned method, any material suitable for the purpose can be applied in the flexible package. Similarly, any closing means material suitable for the purpose and for the flexible package can be applied as blank material for the closing means. However, in the case of a paper package, the method may further comprise the following step before the last above mentioned method step: providing at least the first wall or the second wall of the package with at least one fibre rip stopper, which stopper may thus be a slit or an incision made in the first wall and/or the second wall of the package, the edge of a tab provided in the first wall and/or the second wall e.g. by gluing, or a slit or an incision made in the glued tab; in addition or alternatively, the stopper may also be the edge of a folded wall, such as the edge of the second wall shown in the figure, or only the edge of the wall, such as the edge of the first wall in the figure.

The method can be applied in a packaging machine, for example, by supplying the closing means to package material which is unrolled as a continuous web to the packaging machine. The material for the closing means is introduced in the packaging machine from a separate roll and attached by its adhesive to the surface of the web of package material so that when the package blanks are separated from each other, the closing means of each package blank is suitable for closing the side of the package that is open or intended to be opened.

The flexible package with the closing means can be made by using machines, equipment and methods typically used in the industry.

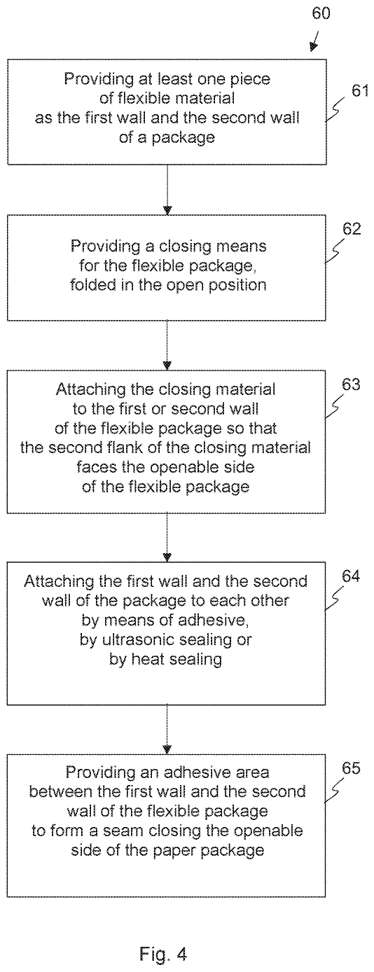

FIG. 4 shows a flow chart of a method 60 for manufacturing a paper package according to the invention. The method 60 comprises at least the following steps, whose sequence may vary. In a method step 61, at least one piece of flexible material is provided, such as a recyclable one, as the first wall and the second wall of a package. In a method step 62, a closing means for the flexible package is provided, folded in the open position. In a method step 63, the closing means is attached to the first or second wall of the flexible package. In a method step 64, the first wall and the second wall of the package are attached to each other by means of adhesive, by ultrasonic sealing or heat sealing. In a method step 65, an adhesive area is provided between the first wall and the second wall, to form a seam closing the openable side of the paper package.

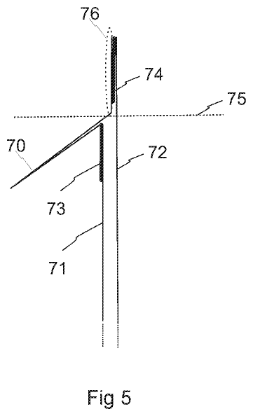

FIG. 5 shows a closing means 70 for a flexible package according to the invention, attached to the flexible package. The attachment surface of the closing means 70 is attached to the first wall 71 of the flexible package, for example by hot-setting adhesive or other bonding adhesive 73. Between its closing surface and the second flank, the closing means 70 comprises a sealing surface 76, on which it is heat sealed to the second wall 72 of the package after the package has been filled; in other words, a heat sealed joint 74 is formed between the sealing surface 76 of the closing means 70 and the second wall 72 of the package. The package is opened by tearing off the top of the package, including the heat-sealed sealing surface 76 of the closing means 70. The tearing location 75 is illustrated by a broken line. After the tearing, the closing means 70 is used in the way shown above; that is, in the closed position, the closing surface of the closing means 70 is attached across the open side to the second wall 72. A hang hole may be provided in the part of the package to be torn off.

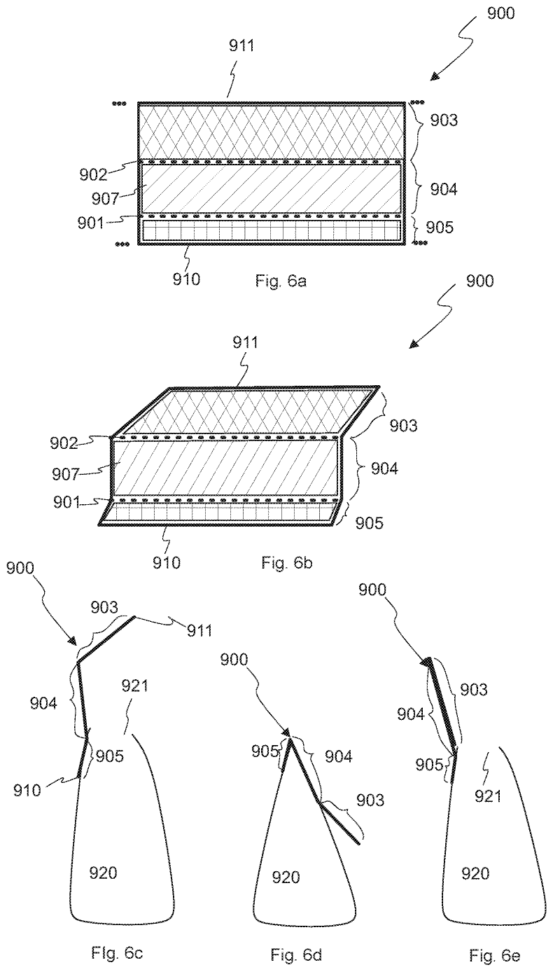

FIG. 6a shows a closing means 900 for a flexible package according to the invention in a non-folded state and seen from the direction of the closing surface, that is, from the surface on which it is configured to close the open side, i.e. mouth, of the flexible package. The closing means 900 of FIG. 6a is a cut-off length, i.e. a piece of a closing means roll; three dots depict directions in which the closing means 900 would extend. The shape of the closing means 900 is often elongated or more elongated in the horizontal direction than in the vertical direction, but its shape and size depend on the shape and size of the package to be closed, and/or the size of the open side of the package intended to be closed. Across the length of the closing means 900, at least three horizontal areas 903, 904, 905 and two horizontal creases 901, 902 are provided, the first crease 901 between the areas 904, 905 and the second crease 902 between the areas 903, 904.

In this embodiment, the attachment surface 905 is between the horizontal first flank 910 and the first crease 901 of the closing means 900, and it is a so-called adhesive coating provided with adhesive, for example hot-setting adhesive or other adhesive suitable for the purpose, whereby it is used, or intended to be used, for attaching the closing means 900 to the outer wall of the flexible package so that the first flank 910 extends downwards. In this embodiment, the closing surface 904 of the re-closable closing means is between the first and second creases 901, 902, and it is a so-called adhesive surface coated with adhesive, for example the same adhesive as the adhesive on the attachment surface 905, or a different adhesive. Adhesive can be applied on either the whole attachment surface 905 or merely a part of it. The same applies to the closing surface 904; that is, its adhesive area 907 may cover the whole closing surface 904 or only a part of it. In this embodiment, the non-adhesive surface 903 is between the second crease 902 and the second flank 911 of the closing means 900, and it may consist of the blank material of the closing means 900 or another non-adhesive material, such as silicone, which is applied or glued onto the blank material of the closing means 900, at the location of the non-adhesive surface 903.

In the closed position, the closing means 900 closes the flexible package, and the re-closable closing surface 904 is removably attached across the open side of the flexible package to the outer wall of the flexible package, opposite to the fastening surface 905, for closing the flexible package. The non-adhesive surface 903 may be used as a flap. In the open position of the flexible closing means, the non-adhesive surface 903 is removably attached to, i.e. placed against, the closing surface 904 and vice versa; that is, the closing surface 904 is placed against the non-adhesive surface 903, from which the closing surface 904 can, thanks to the non-adhesiveness of the non-adhesive surface 903, be easily removed across the open side of the package to close the package. The non-adhesive surface 903 and the closing surface 904 have, with respect to each other, such a size that the closing surface 904 is either equal to or smaller than the non-adhesive surface 903, so that no adhesive section of the closing surface 904 will remain outside the area of the non-adhesive surface 903 when they are placed against each other in the open position.

Although there is no separate flap in this embodiment, opening and closing of the package, that is, shifting from the open position to the closed position and vice versa, is facilitated by the non-adhesive surface 903 between the re-closable closing surface 904 (as well as the crease 902) and the second side 911. The adhesives on the attachment surface 905 and on the closing surface 904 may be the same adhesive or different adhesives. For better bonding of the closing means 900 to the package, a stronger adhesive is often used on the attachment surface 905 than on the closing surface 904.

FIG. 6b shows a perspective view of the closing means 900 of FIG. 6a, folded at the creases 901, 902.

FIG. 6c shows a cross-sectional side view of the closing means 900 of FIG. 6a when the closing means 900 is attached to a flexible package 920. In FIG. 6c, the closing means 900 is attached to the flexible package 920 but it is not in the closed or open position but in an intermediate position, in which the package 920 and its open side 921 are open and the closing surface 904 and its adhesive area 907 are unprotected, that is, not against the package or the non-adhesive surface 903.

FIG. 6d shows a cross-sectional side view of the package 920 and the closing means 900 of FIG. 6c when the closing means 900 is attached to the flexible package 920 and in the closed position, in which the closing means 900 and its closing surface close the flexible package 920 and its open side 921 from above. The closing surface 904 and its adhesive area 907 are against the second outer wall of the package 920.

FIG. 6e shows a cross-sectional side view of the package 920 and the closing means 900 of FIG. 6c when the closing means 900 is attached to the flexible package 920 and folded in the open position, in which the flexible package 920 and its open side 921 are open. The closing surface 904 and its adhesive area 907 are against the non-adhesive surface 903.

The first crease 901 may also be flush with the top edge of the flexible package 920, whereby the closing means 900 closes the package 920 as tightly as possible. Moreover, the first crease 901 may be above the open side 921, whereby, upon closing the package 920, the re-closable closing surface 904 is attached partly to the attachment surface 905 and only then to the second outer wall, i.e. the front wall, of the flexible package 920.

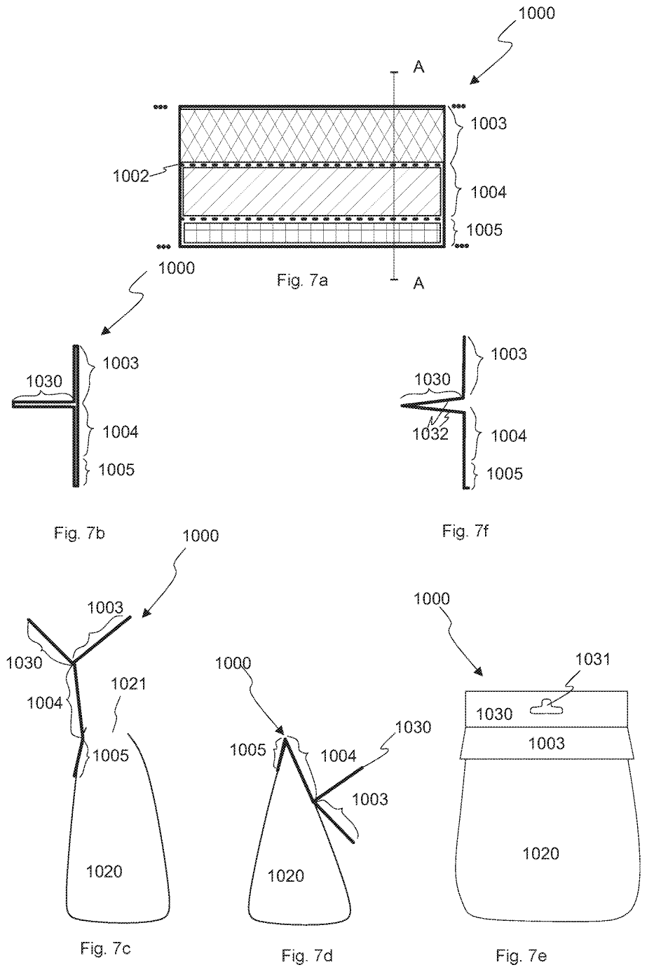

FIG. 7a shows a closing means 1000 for a flexible package according to the invention, unfolded and seen from the direction of the closing surface, i.e. the surface by which the closing means 1000 is arranged to close the open side, i.e. mouth, of the flexible package. The closing means 1000 of FIG. 7a is a cut-off length, i.e. a piece of a closing means roll; three dots depict directions in which the closing means 1000 would extend. However, it is possible to make the closing means 1000 or the closing means according to other embodiments ready in a given length. In other respects, the closing means 1000 corresponds to the closing means 900 shown in FIGS. 6a to 6e, but the gripping flap 1030 in the closing means 1000 is provided on the surface opposite to the closing surface. The gripping flap 1030 is shown in FIGS. 7b to 7f. The gripping flap 1030 is a plane protruding, for example, transversely or obliquely from the surface opposite to the closing surface of the closing means. An example of forming the gripping flap 1030 is shown in FIG. 7f. It should be noted that there is also an alternative location for the gripping flap 1030, which is in some situations even more preferable. This location is in the first crease, i.e. the crease between the attachment surface 1005 and the closing surface 1004. Thus, when the package is moved by gripping the gripping flap 1030, the forces exerted on the closing means 1000 are transferred very linearly to the top edge of the package and hardly tend to open the joint between the closing surface 1004 and the second outer wall. Thus, the closing means keeps the package closed more strongly and securely.

FIG. 7b shows the closing means 1000 at the location of the section A-A shown in FIG. 7a and seen from the end of the closing means 1000. In this embodiment, the gripping flap 1030 protrudes in a substantially transverse direction from the surface opposite to the closing surface of the closing means 1000.

FIG. 7c shows a cross-sectional side view of the closing means 1000 of FIG. 7a when the closing means 1000 is attached by its attachment surface 1005 to the flexible package 1020 but is not in the closed or open position but in an intermediate position between them, and the package 1020 and its open side 1020 are open.

FIG. 7d shows a cross-sectional side view of the package 1020 and the closing means 1000 of FIG. 7c when the closing means 1000 is attached by its attachment surface 1005 to the first outer surface of the flexible package 1020 and is in the closed position, in which the closing means 1000 closes the flexible package 1020 from above. In the closed position, the closing surface 1004 is against the second outer wall of the package 1020. The first and second walls are opposite walls.

FIG. 7e shows a front view of the package 1020 and the closing means 1000 of FIG. 7d when the closing means 1000 is attached to the flexible package 1020 and is in the closed position. As seen in FIG. 7e, the gripping flap 1030 points substantially upwards from the package 1020 in the closed position. The gripping flap 1030 may extend over the whole width of the closing means 1000, but it may also be narrower, i.e. extend over only a part of the closing means 1000. The gripping flap 1030 may comprise a hang hole 1031. The hang hole 1031 may be a so-called euro hole for hanging on a shelf in a store, for example on a bar on a shelf, where the flexible package can be easily picked up. The appearance of the flexible package 1020 remains neat when it is hung in a suspended position. In addition to hanging, the gripping flap 1030 can be used to change the position of the closing means 1000 or to facilitate the changing of the position from the open position to the closed position and vice versa, when the user holds the gripping flap while manipulating the closing means 1000. Opening and closing the flexible package 1020 are facilitated further if the closing surface 1004 and/or the non-adhesive surface 1003 of the flexible package 1020 have been stiffened, for example by an additional material layer, such as a strip of material. In this case, the crease 1002 acts as a hinge, or at least in a way resembling a hinge. The strip of material may consist of, for example, cardboard, paper tape or any other material suitable for the purpose and glued on the surface 1004 and/or 1003.

The gripping flap 1030 for the closing means 1000 can be formed of the closing means blank of FIG. 7f for example in the following way. The gripping flap 1030 is formed by protruding surfaces 1032 extending between the closing surface 1004 and the non-adhesive surface 1003, which have been folded against each other and away from the closing surface formed by the closing surface 1004 and the non-adhesive surface 1003 as well as the attachment surface 1005. The protruding surfaces 1032 can be glued together. Thus, the closing means 1000 with a gripping flap 1030 can be made by folding from a single uniform material blank.

However, it is also possible to manufacture a closing means with a gripping flap in another way, for example by gluing the gripping flap 1030 onto the surface opposite to the closing surface of the closing means. The gripping flap 1030 may be formed at or attached to the junction of the closing surface 1004 and the non-adhesive surface 1003.

In FIGS. 7a to 7f, the gripping flap is formed at the second crease of the closing means, between the closing surface 1004 and the non-adhesive surface. Similarly, the gripping flap can be formed in the first crease of the closing means, between the attachment surface 1005 and the closing surface 1004. An advantage of this is that forces caused by the hanging or manipulating of the package and effective on the package are transmitted via the gripping flap 1030 directly to the attachment surface and further to the package. When the gripping flap 1030 is in the second crease of the closing means, as shown in FIGS. 7a to 7f, these forces are transmitted to the package via the closing surface 1004 which may limit the use of the gripping flap to manipulating and hanging of the package.

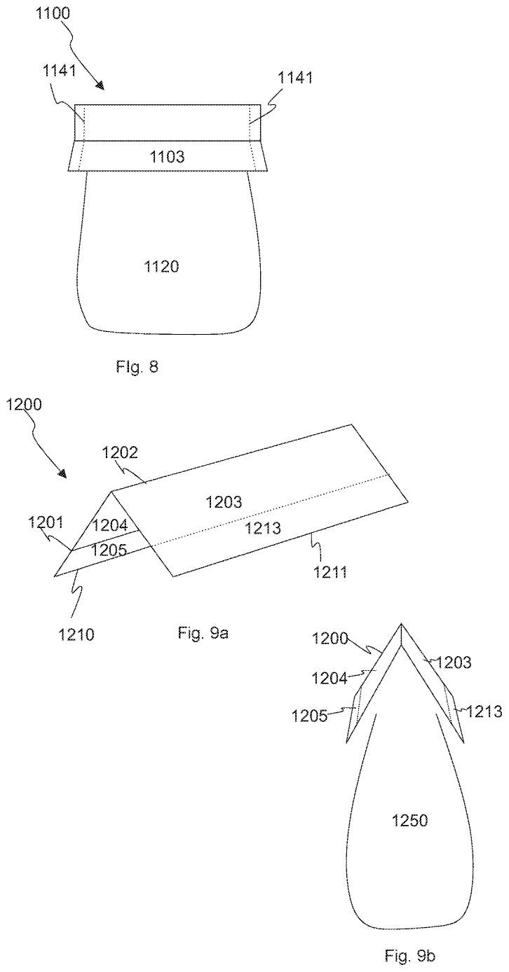

Another advantage of the invention, not mentioned before, is a sealing embodiment of the invention, wherein the closing means is arranged wider than the flexible package to which it is attached. That is to say, when the flexible package is seen either from the front or from behind, the closing means extends beyond its side seams in the width direction. In this embodiment, the closing means is in the closed position, i.e. it closes the flexible package, and the parts extending beyond the sides of the flexible package are sealed together in the vertical direction. Thus, to open the closing means and the flexible package, the seams of the closing means have to be torn or cut off, whereby the closing means also acts as a seal and an indicator that the flexible package has not been opened before, for example without permission. This embodiment is shown in FIG. 8.

FIG. 8 shows a front view of a closing means 1100 according to an embodiment, attached to a flexible package. The closing means 1100 is arranged wider than the flexible package 1120. As seen in FIG. 8, the closing means 1100 is in the closed position, and the closing means 1100 is wider than the flexible package 1120. The flexible package 1120 may contain or not contain products, but for opening the package 1120, the edge part of the closing means 1100 has to be torn off substantially at tearing lines 1141. After this, the closing means 1100 operates normally and can be opened and re-closed like the other embodiments of the closing means presented. The edge parts of the closing means 1100, to be torn off, may have been seamed in the vertical direction on both sides of the package 1120. The closing means 1100 may or may not comprise a flap 1103 for facilitating the opening.

In this embodiment, too, the closing surface and/or the non-adhesive surface of the closing means 1100 may be stiffened as in the other embodiments presented in the application, to facilitate opening and closing. For example, the material strip may consist of cardboard glued onto the closing surface and/or the non-adhesive surface, of paper tape, or of any other material suitable for the purpose.

FIG. 9a shows a closing means 1200 according to an embodiment which can be attached to a flexible package of takeaway food, for example a package of fast food, after being filled, to make sure that the delivery service or the like is not in contact with the product during its delivery. In this case, too, the closing means 1200 may be wider in the side direction than the flexible package to which it is intended to be attached, so that when attached to the package it will adhere together on the outside of the sides of the flexible package and act as a seal in the same way as the closing means 1100 of FIG. 8. Along the length of the closing means 1200, there are at least three horizontal areas 1203, 1204, 1205 and two creases, the first crease 1201 between the areas 1204, 1205 and the second crease 1202 between the areas 1203, 1204. Also in this embodiment, the attachment surface 1205 is between the horizontal first flank 1210 of the closing means 1200 and the first crease 1201, and it is a so-called adhesive surface coated with adhesive by which the closing means 1200 is attached or intended to be attached to the outer wall of the flexible package so that the first flank 1210 extends downwards. The adhesive on the attachment surface 1205 may have been protected by a release paper or the like which is removed before the closing means 1200 is attached to the flexible package. A non-adhesive surface 1203 is provided between the second crease 1202 and the second flank 1211, and it may consist of the blank material of the closing means 1200 or another non-adhesive material, such as silicone, which applied or glued onto the blank material of the closing means 1200, in the area of the non-adhesive surface 1203. The re-closable closing surface 1204, in turn, is provided between the first and second creases 1201, 1202 in this embodiment, and it is a so-called adhesive surface coated with adhesive, for example the same adhesive as the adhesive on the attachment surface 1205, or a different adhesive. Also, the adhesive on the re-closable closing surface 1204 may be protected with a release paper or the like which is removed before the closing means 1200 is attached to the flexible package, or the re-closable closing surface 1204 may be placed against the non-adhesive surface 1203 until the closing means 1200 is taken into use and the surfaces are detached from each other for attaching the closing means 1200 to the flexible package 1250.

Between the non-adhesive surface 1203 and the second flank 1211 of the closing means 1200, a non-adhesive section may be provided, to be used as a flap 1213. All the material layers of the closing means are provided on the inner surface of the fold, which is the closing surface.

The closing means 1200 may be reinforced, for example a closing means made of paper, or it may be made of a material stiffer than paper, such as cardboard. Thanks to the stiffer structure, the closing means 1200 is easier to attach to the top of the flexible package in the position shown in FIG. 9a, as a fold open downwards, and it adheres to the package 1250 at the locations of the attachment surface 1205 and the re-closable closing surface 1204. FIG. 9b shows the way and direction of affixing to the flexible package 1250.

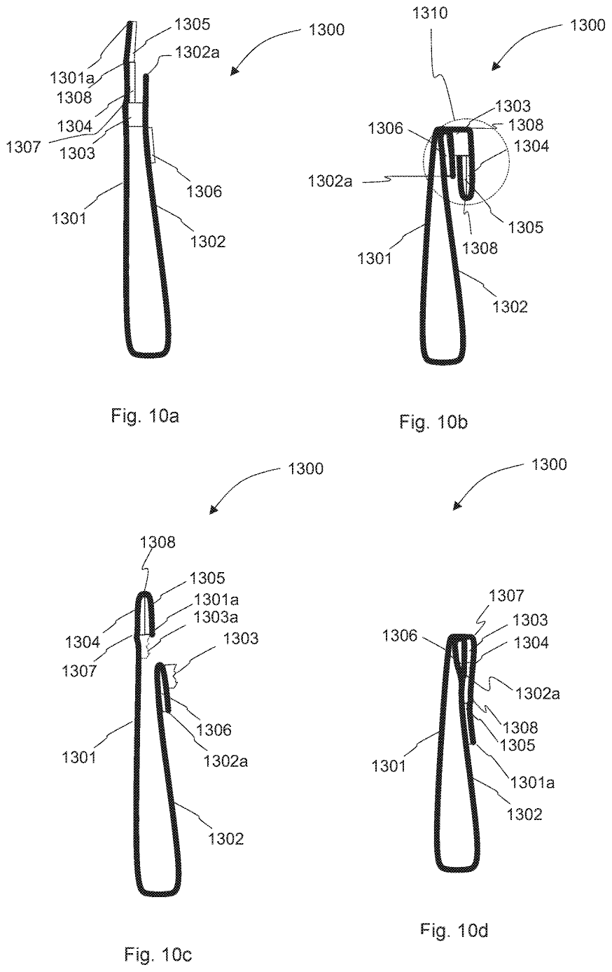

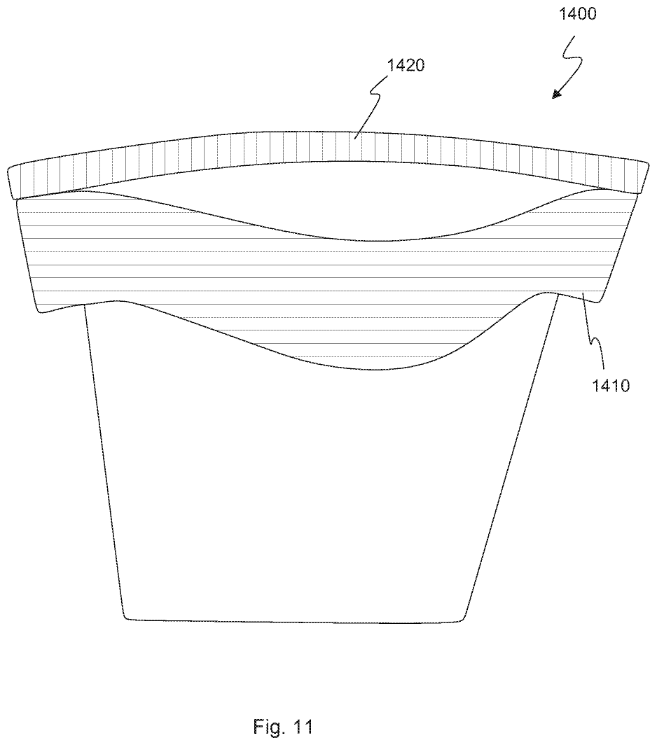

FIG. 10a shows a cross-sectional side view of the structure of a flexible package according to an embodiment, equipped with an adhesive closing means and a flap. In this context, ‘equipped with an adhesive closing means’ means that the flexible package 1300 is re-closable. The open side of the flexible package 1300 is heat sealed at this stage and in this position of the flexible package. After being opened, the side heat-sealed in this figure is intended to be re-closed by the closing means, to be openable. The flexible package 1300 with the closing means comprises a first wall 1301, a second wall 1302, and the closing means as an extension to the first wall 1301. This closing means comprises two creases 1307, 1308, a re-closable closing surface 1304, and a non-adhesive surface 1305. The first crease 1307 is at the so-called end point of the first wall 1301, from which the closing means and its re-closable closing surface 1304 extend, and the second crease 1308 is between the re-closable closing surface 1304 and the non-adhesive surface 1305. Reference numeral 1303 denotes the above-mentioned heat seal by which the first wall 1301 and the second wall 1302 are sealed together. Reference numeral 1306 denotes adhesive by which the end 1302a of the second wall 1302 is arranged to be glued when folded partly onto the second wall 1302, whereby also the first wall 1301 and its re-closable closing surface 1304 and non-adhesive surface 1305 are folded partly onto the second wall 1302, to form a flap. The end of the first wall 1301 is denoted by reference numeral 1301a.

FIG. 10b shows a cross-sectional side view of the flexible package equipped with a closing means as shown in FIG. 10a, the openable side heat-sealed before the flexible package is opened. In this figure, however, the flexible package 1300 with the closing means is shown in an openable form; that is, the figure shows how the top of the flexible package 1300 is folded onto the second wall 1302, to form a flap 1310. The flap 1310 is thus glued on by gluing the end 1302a of the second wall 1302, folded double, with adhesive 1306.

In this figure, the non-adhesive surface 1305 is folded at the second crease 1308 onto the re-closable surface 1304, to prevent the non-adhesive surface 1305 from drying; that is, the end of the first wall 1301 is folded double, whereby the re-closable closing surface 1304 attaches to the non-adhesive surface 1305 in a detachable way. However, this step may be omitted and the closing means section of the first wall 1301 may be left unfolded, i.e. extended.

FIG. 10c shows a cross-sectional side view of the flexible package 1300 equipped with a closing means as shown in FIG. 10b, after the flexible package 1300 has been opened by lifting the flap 1310. FIG. 10c shows that the heat seal 1303 has been detached from the first wall 1301 and remained attached to the second wall 1302. It may also remain attached to the first wall 1301. This situation is shown by the reference numeral 1303a in the figure. It is also possible that the heat seal 1303 is ripped in the middle of the seam, and parts of it remain attached to both the first wall 1301 and the second wall 1302.

The end 1306 of the second wall 1302 acts as a fibre rip stopper to prevent the package 1300 from being torn when it is opened by lifting the flap 1310. A second fibre rip stopper may be provided between the first wall 1301 and the re-closable closing surface 1304 as well as the non-adhesive surface 1305; that is, below the re-closable closing surface 1304 and the non-adhesive surface 1305. This fibre rip stopper may be, for example, a strip, such as a strip of paper or a strip of paper tape. Similarly, the first wall 1301 can be folded to form more layers than shown in e.g. FIGS. 10b to 10d, to form e.g. a so-called z-fold, that is, a triple fold.

FIG. 10d shows a cross-sectional side view of the flexible package 1300 equipped with a closing means as shown in FIG. 10c, after the flexible package 1300 has been re-closed by attaching the re-closable closing surface 1304 across the open side of the package 1300 to the outer surface of the second wall 1302 of the package 1300.

Although the re-closable closing surface 1304, the non-adhesive surface 1305, the heat seal 1303 and the adhesive 1306 are illustrated, in this context, clearly as separate boxes on the material of the flexible package 1300, the height of the boxes in the figure does not correspond to reality. Furthermore, for example the non-adhesive surface 1305 may consist merely of the material of the flexible package, without coating, but it may comprise silicone or consist of silicone as well.

Yet another advantage of the invention, not mentioned before, is the increase in printable surface area. When the top of a conventional flexible package is torn off to open the package, a strip of it comes off. Consequently, it is not worth writing any essential information on the product of the package in this section to be removed. As a result, the top to be torn off often only contains the text “tear off here”. The closing means according to the invention, although covering part of the bag, provides more printable surface area for the package comprising the closing means. Also, the siliconized area of the closing means can be printed to contain desired information, as long as this is done before the area is siliconized. The user may pay more attention to the top of the package than the other parts of the package because it comprises, for example, the open mouth of the bag. One could also presume that one's eyes would be caught particularly by the moving and movable closing means according to the invention at the top of the package, and simultaneously by the printing on it.

Furthermore, it should be noted that in some cases, the closing means may be a direct extension of the material of the flexible package, i.e. a part of the material blank folded to form the flexible package. In such a case, the closing means does not require a separate attachment surface.

In addition to those presented above, a structure is also possible in which a reinforcement is attached to the top of the second wall, so-called front wall, of the package, the outer surface thereof. The attachment surface of the closing means reinforces the first wall, so-called rear wall, in a corresponding way.

When the closing means is formed of an extension of the first wall, it is preferable to reinforce not only the top of the front wall but also the top of the rear wall with an external reinforcement. Thus, the reinforcements are aligned in the package, normally having the same size, and provided on opposite walls.

The width of the reinforcement may be, for example, approximately 25 to 40 mm, but the width may be different as well. Attached to the package, the reinforcement has a width extending in the vertical direction. The width of the reinforcement in the vertical direction is preferably equal to or greater than the width of the closing surface of the closing means in the vertical direction because the closing means is attached to it in the closed position. The heat sealing of the flexible package is provided in the area of the reinforcement, in the lower part of the reinforcement area, for example spaced by approximately 5 to 10 mm from the bottom edge of the reinforcement. The reinforcement is preferably a self-adhesive tape, or it may be a reinforcement strip to be attached by adhesive. To attach the reinforcement tape, it is sufficient to press the tape onto the top edge of the package, outside the package. Thanks to the reinforcement, the top edge of the package becomes stiffer and straight, whereby the package can be closed more tightly by the closing means.

Because the reinforcement reinforces the wall of the flexible package, the walls of the package can be pulled apart instead of ripping the package open in the side direction. This opening method works, in practice, with all paper grades. Also with some newer fibre materials, the risk of a fibre tear is low upon opening the package by pulling the walls apart when the package is opened carefully, but with most materials it is not. The wall of the package may be torn. Thanks to the reinforcement, the tear cannot continue when the package is opened, and except for the small local tear inside the package, the package will remain intact.

Consequently, the reinforcement attached to the front wall of the package reinforces the wall of the package and binds the fibres. Thus, the heat sealing of the package can be opened by spreading out the mouth, whereby the top edge remains straight. As a result, the closing means closes the mouth of the bag really tightly. The reinforcement has a width at least equal to the width of the package, as has the closing means. Even if the package is torn when opened, this is not visible from under the reinforcement, and above all, the fibre binding effect of the reinforcement will prevent the tear from extending, whereby the package is not broken in a visible way and does not become difficult to use. On a thin package material, the reinforcement reinforces the mouth of the package so that it opens neatly in a curve, improving the ease of use. Moreover, the package material may be thinner, which provides material savings. A reinforcement containing silicone or other dirt-repelling coating prevents fibres from adhering to the re-closable closing surface, whereby it is not blocked. When the reinforcement has a repellent surface, contents of the package do not adhere to it as easily as to a package material having a matte finish. This prolongs the usable life of the re-closable closing surface. The reinforcement on the front side may also secure that the re-closable closing surface is always detachable by equal force from different bag materials. Thus, the manufacturer will avoid costs for developing the adhesive for the closing surface, because the reinforcement material will remain the same even if the package material were changed. Furthermore, the reinforcement prevents the adhesive of the closing surface from drying before the package is emptied of its contents, because the reinforcement is poorly permeable to oxygen, compared to a situation in which the adhesive is in contact with porous bag material.

FIG. 11 shows a front view of a flexible package 1400 equipped with a reinforcement 1410 and a closing means 1420, the closing means 1420 being in the open position. In this FIG. 11, the package 1400 is open and formed in a curve, thanks to the reinforcement 1410. The reinforcement 1410 and the closing means 1420 have a width at least equal to the width of the whole package 1400, but in this example, they are both wider than the package 1420; they may also have mutually different widths. The closing means 1420 is glued to the first i.e. rear wall of the package 1400, and the reinforcement is glued to the second i.e. front wall of the package 1400, at the top and on the outer surface.

When the reinforcement 1410 is wider than the package 1400, a reinforcement protrusion is formed across the side edge of the package 1400, which can be folded and attached behind the package 1400 or in a lateral fold, or it can be fastened against one long closing means 1420, as shown in this example of FIG. 11.

The reinforcement may also be fastened against one long reinforcement attached to the top edge of the rear wall of the package. If the reinforcements of the front and rear walls extend outside the edges of the package, this will strengthen the side seams at the top of the package which are, in fibre bags, more susceptible to yield than in plastic bags, in which the seam is formed by two edges fused together.

When the flexible package comprises both a closing means and a fibre rip stopper, as shown in FIGS. 1a, 1b, 2a, and 2b, a tape or strip is provided on the inner surface of the wall of the package. When, in turn, the package comprises a closing means and a reinforcement, as shown in FIG. 11, the tape or strip is provided on the outer surface of the wall of the package.

Furthermore, when the package is half empty, it is possible to press the walls of the empty part of the package against each other and then fold them onto the filled part of the bag, and first after that fasten the re-closable closing surface of the closing means to the outer surface of the second wall of the package and further, below the package, to the first wall, if the package is sufficiently empty. Moreover, if the re-closable closing surface of the closing means is made of a flexible and pliable material and the closing means is fastened to a sufficiently low position on the rear wall, the flexible package can also be closed by the closing means in such a way that the re-closable closing surface is attached partly to the rear wall of the flexible package and, having passed across the mouth, to the front wall of the flexible package.

The embodiments presented in the application are suitable for use in a flexible package comprising a fibre rip stopper. It should also be noted that a heat-sealed package comprising a closing means and a reinforcement is a single unit, because the top edge of the package with a reinforcement remains straight and intact when opened, which secures tighter closure by the closing means.

The features of the invention described and the embodiments mentioned in the application are freely combinable and interchangeable, except if the application particularly states that the embodiments or features are not interchangeable. The exemplary features described in connection with the different embodiments can be used with any other embodiment even if this were not mentioned separately.

1. A closing means for closing an open side of a flexible package, the closing means comprising a material blank which comprises at least two creases, an attachment surface, a re-closable closing surface, and a non-adhesive surface, wherein said attachment surface is provided with adhesive by which the closing means is intended to be attached to a first outer wall of the flexible package, and the attachment surface is provided between a first flank and the first crease of the closing means,
and wherein the non-adhesive surface of the closing means is provided between the second crease and the second flank of the closing means, wherein the re-closable closing surface arranged between the first and second creases is provided with adhesive, and the closing surface has a size either equal to or smaller than the non-adhesive surface and is arranged to be removably attached, in the closed position of the closing means, across the open side of the flexible package to the second outer wall of the flexible package and, in the open position, to the non-adhesive surface of the closing means.

2. The closing means according to claim 1, wherein the non-adhesive surface consists of uncoated material of the material blank.

3. The closing means according to claim 1, wherein the non-adhesive surface consists of silicone or comprises silicone.

4. The closing means according to claim 1, wherein the edge area of the second flank on the non-adhesive surface is free from adhesive and is used as a flap.

5. The closing means according to claim 1, wherein the edge area of the non-adhesive surface on the side of the second flank is partly folded double and glued from the direction of the second flank, to form a flap.

6. The closing means according to claim 1, wherein a strip of material is glued onto the edge area of the second flank of the non-adhesive surface, to form a flap.

7. The closing means according to claim 1, wherein the material of the material blank is recyclable paper fibre.

8. The closing means according to claim 1, wherein the re-closable closing surface or the non-adhesive surface is stiffened with a separate material layer.

9. The closing means according to claim 1, wherein the material of the material blank is compostable or biodegradable fibre material, compostable film material, plastic, laminate, or aluminium foil.

10. The closing means according to claim 1, comprising a gripping flap provided on the side of the closing means opposite to the re-closable closing surface, at the joint of the re-closable closing surface and the non-adhesive surface, or at the joint of the attachment surface and the re-closable closing surface.

11. The closing means according to claim 1, comprising a reinforcement at the top of the second wall of the package, outside the wall.

12. A re-closeable flexible package comprising a closing means, wherein the closing means according to claim 1 is attached to the outer surface of the first wall of the flexible package by the attachment surface of the closing means, or wherein the closing means is an extension to the first wall comprising at least two creases, a re-closable closing surface and a non-adhesive surface; which the non-adhesive surface of the closing means is provided between the second crease and the second flank of the closing means, and which said re-closable closing surface is arranged between the first and second creases, and wherein adhesive is provided on said re-closable closing surface, whose size is either equal to or smaller than the non-adhesive surface; and wherein the attached closing means or the closing means being an extension to the first wall is configured to close the flexible package when the re-closable closing surface is removably attached across the open side of the flexible package to the outer surface of the second wall of the flexible package, and the flexible package is open when the re-closable closing surface is against the non-adhesive surface of the closing means.

13. The flexible package according to claim 12, wherein the material of the flexible package is recyclable paper fibre, compostable or biodegradable fibre material, compostable or biodegradable film material, plastic, laminate, or aluminium foil.

14. The flexible package according to claim 12, wherein the material of the flexible package is fibre material, and its openable side comprises a fibre rip stopper in connection with the seam closing the open side.

15. The flexible package according to claim 12, wherein the closing means is wider than the flexible package in the closed position, and wherein the flexible package is openable by detaching the edge parts of the closing means which are wider than the flexible package.

16. (canceled)

17. The flexible package according to claim 12, wherein the edge area of the second flank on the non-adhesive surface is free from adhesive and is used as a flap.

18. The flexible package according to claim 12, wherein the closing means comprises a gripping flap provided on the side of the closing means opposite to the re-closable closing surface, at the joint of the re-closable closing surface and the non-adhesive surface, or at the joint of the attachment surface and the re-closable closing surface.

19. The flexible package according to claim 12, wherein the closing means comprises a reinforcement at the top of the second wall of the package, outside the wall.

20. A method for manufacturing a flexible package equipped with a closing means, wherein the method comprises at least the following steps:
providing at least one piece of flexible material as the first wall and the second wall of the flexible package;
providing a closing means for the flexible package, folded in an open position;
attaching a closing means according to claim 1 to the first wall of the flexible package, if the closing means is not an extension to the first wall;
attaching the first wall of the flexible package and the second wall of the flexible package to each other by means of adhesive, by ultrasonic sealing or by heat sealing; and
providing an adhesive area between the first wall and the second wall of the flexible package to form a seam closing the openable side of the flexible package.
